(19) United States
(12) Patent Application Publication
(10) Pub. No.: US 2003/0180026 A1
(43) Pub. Date: Sep. 25, 2003

(54) In-line attenuation in optical fiber

(76) Inventor: August M. Spannagel, Berkeley, CA (US)

Correspondence Address: MARK C. ZIMMERMAN, GROSSMAN & FLIGHT, LLC., SUITE 4220, 20 NORTH WACKER DRIVE, CHICAGO, IL, 60606, US

(21) Appl. No.: 10/102,249

(22) Filed: Mar. 20, 2002

(51) Int. Cl. G02B 6/00; G02B 6/255

(52) U.S. Cl. 385/140; 385/97

(57) ABSTRACT

A technique of making a seamless in-line attenuator in optical fiber and attenuator made by the same are disclosed. The technique includes determining an initial offset between the longitudinal axes of optical fibers to be spliced, as well as a heating time for making the splice. As the optical fibers are heated, the longitudinal centers of the optical fibers are pulled together to a second offset that is smaller than the first offset. The result is a splice having desired attenuation and significant tensile strength.

### TECHNICAL FIELD

The present disclosure relates generally to fiber optics and, more particularly, to techniques for fabricating in-line attenuators in optical fiber.

### DESCRIPTION OF THE RELATED ART

High speed optical systems including an optical transmitter and an optical receiver linked by optical fiber are prevalent in many of today's voice and data communication systems. The lightweight and flexible nature of optical fiber, along with the large data transmission bandwidth the fiber can accommodate, make optical systems highly desirable for many different information exchange applications. Optical transmitters may operate at wavelengths between 1300 and 1510 nanometers (nm) and may transmit data at a rate of 10 gigabits per second (Gbs) or more through optical fiber having a diameter on the order of 250 μm.

The process of manufacturing optical transmitters inherently produces batches of optical transmitters including individual transmitters having different output powers. For example, a manufacturing process designed to produce optical transmitters having output powers of 3 decibels above a milliwatt (dBm) may, in reality, produce transmitters having a distribution of output powers that may, for example, range from 2.5 dBm to 3.5 dBm. This variation in output power across individual transmitters of batches of transmitters is troublesome to optical transmitter manufacturers because many purchasers of optical transmitters desire to purchase transmitters having a fixed output power. For example, a first purchaser may desire to purchase optical transmitters having precisely a 1 dBm output power, while a second purchaser may desire to purchase optical transmitters having precisely a 2 dBm output power. In such cases, very few optical transmitters of the lot of transmitters designed, for example, to have 2 dBm power outputs would be suitable for shipment to such customers.

To ensure that nearly all of the optical transmitters that are produced are shipped to customers, optical transmitters have typically been designed to have output powers that are much greater than the customer desires so that even transmitters on the low side of the output power distribution have output powers greater than the power required by the customer. The overpowered optical transmitters, which are manufactured having a 250 μm fiber optical cable pigtail hanging therefrom, are then coupled to attenuators that dissipate the excess optical transmit output power so that the resulting power level is a power level desired by the customer. For example, a manufacturer may produce optical transmitters having output powers on the order of 10 dBm and may then attenuate the output power to a 3 dBm level, if such a level were required by a customer.

One technique for providing attenuation of an optical transmitter includes attaching or splicing a 250 μm fiber optic extension onto the 250 μm fiber optic pigtail of an optical transmitter, wherein the longitudinal axes of the fiber optic extension and the fiber optic pigtail are abruptly offset from one another. The abrupt offset in the longitudinal axes of the fibers causes attenuation because not all of the optical energy in the fiber optic pigtail can traverse the offset and be coupled to the fiber optic extension.

To make such an abrupt offset splice, the optical fibers in the pigtail and the extension are brought into proximity at the desired offset. A fusion splicer is then used to heat the optical fibers of the pigtail and the extension to fuse the two together with the desired offset between the longitudinal axes of the fibers, which define the radial centers of the fibers. Importantly, the distance between the longitudinal axes of the optical fibers does not change during the fusing process.

As shown in FIG. 1, an optical transmitter 6 is coupled to an optical receiver 8 by a first optical cable 10 including a glass core 12, glass cladding 14 and an acrylic coating 16 that is abruptly spliced to a second optical cable 20, which also includes a glass core 22, glass cladding 24 and an acrylic coating 26. The claddings 14, 24 and the cores 16, 26, which are generally referred to as the optical fibers 17, 27, are abruptly offset from one another at an abrupt junction 30. The abrupt junction 30 and the abrupt offset between the longitudinal axes of the optical fibers 17, 27 creates attenuation. For example, if optical energy is flowing from the first optical fiber 17 to the second optical fiber 27, at the abrupt junction 30 optical energy in the core 12 of the first optical fiber 17 will be coupled into the cladding 24 of the second optical fiber 27 in the area on FIG. 1 referred to by reference numeral 32, thereby reducing the magnitude of the optical energy coupled into the core 22 of the second optical fiber 27. The magnitude of the energy coupled into the cladding 24 of the second optical fiber 27 at the abrupt junction 30 dictates the attenuation of the offset splice.

In theory, the greater the offset between the radial centers of the pigtail and the extension, the greater the optical attenuation of the splice. For example, offsets such as 1-2 μm could yield between 3 and 15 decibels (dB) of attenuation. One significant drawback to the abrupt offset splice is that it severely compromises the tensile strength of the fiber, because the fiber has a tendency to break at the splice. The GR-468-Core Telcordia Laser Module Specification Fiber Pull test specifies that optical cables, including all splices, must have a 1 kilogram (kg) tensile strength, which is tested by pulling the fiber with one kilogram of force three times in five seconds. Accordingly, optical transmitters using abrupt offset splices must still pass the Telcordia tensile strength metric or many purchasers will not even consider purchasing the optical transmitters.

While attenuations of up to 15 dB are possible using the offset splice procedure outlined above, offsets yielding more than 3 dB of attenuation will not meet the Telcordia tensile strength specification. Recognizing the need to comply with the Telcordia specification, many optical transmitter suppliers use a protective sleeve (not shown), which is commercially available from Ericsson, that is mounted over the abrupt junction 30 and the exposed optical fibers 17, 27 to compensate for the degradation in tensile strength that the abrupt junction causes. In comparison to the diameter of the 250 μm cable, the protective sleeve, which may be 40 millimeters (mm) in length and 2 mm in diameter, is very bulky. Additionally, the sleeve prevents the optical cable 10, 20 from being pulled though tight spaces, bent or coiled around objects or otherwise discretely packaged. Purchasers of optical transmitter would like the protective sleeve to be eliminated from optical transmitters, but also demand that the Telcordia tensile strength specification be met.

### BRIEF DESCRIPTION OF THE DRAWINGS

FIG. 1 illustrates the relationship between two optical fibers that are fused together in a known manner to form an abrupt junction that provides attenuation;

FIG. 2 is an exemplary flow diagram depicting a manner in which optical fibers may be fused at a junction that provides attenuation and enhanced strength;

FIG. 3 is an exemplary illustration of two optical cables to be fused according to the technique of FIG. 2;

FIG. 4 is an exemplary illustration of the two optical cables of FIG. 3 after a portion of the acrylic coating is stripped therefrom;

FIG. 5 is an exemplary illustration of the two optical cables of FIG. 4 after the cladding and core have been cleaned;

FIG. 6 is an exemplary illustration of the two optical cables of FIG. 5 after the ends of the optical fibers have been cleaved;

FIG. 7 is an exemplary plot of attenuation as a function of initial offset, for a fixed heating time;

FIG. 8 is an exemplary illustration of the two optical cables of FIG. 6 mounted in a fusion splicer;

FIG. 9 is an exemplary illustration of the two optical cables of FIG. 8 after splicing; and

FIG. 10 is an exemplary illustration of the two spliced optical cables of FIG. 9 after recoating.

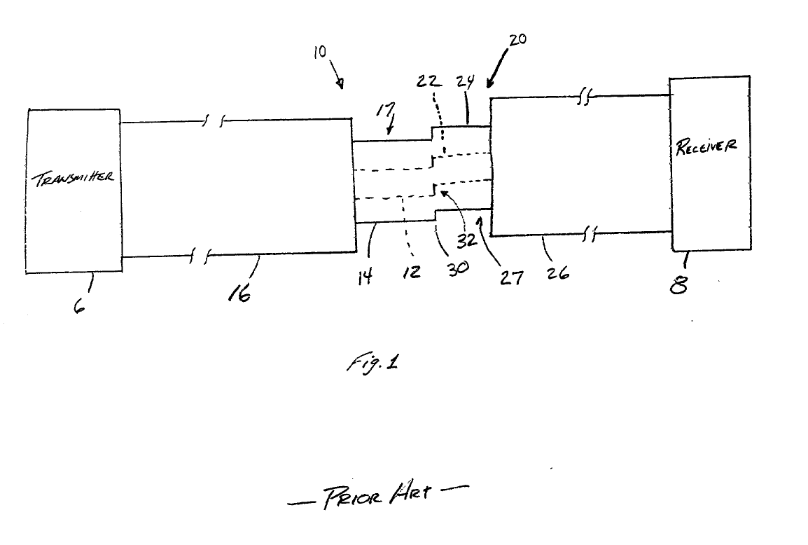

### DESCRIPTION

As disclosed in detail hereinafter, an improved technique for splicing optical fibers to make an attenuator includes offsetting the optical fibers by a first distance and moving the optical fibers to a second offset distance, which is smaller than the first distance, as the optical fibers are heated. The technique disclosed herein yields greater attenuation for a given tensile strength than previously known abrupt junction techniques.

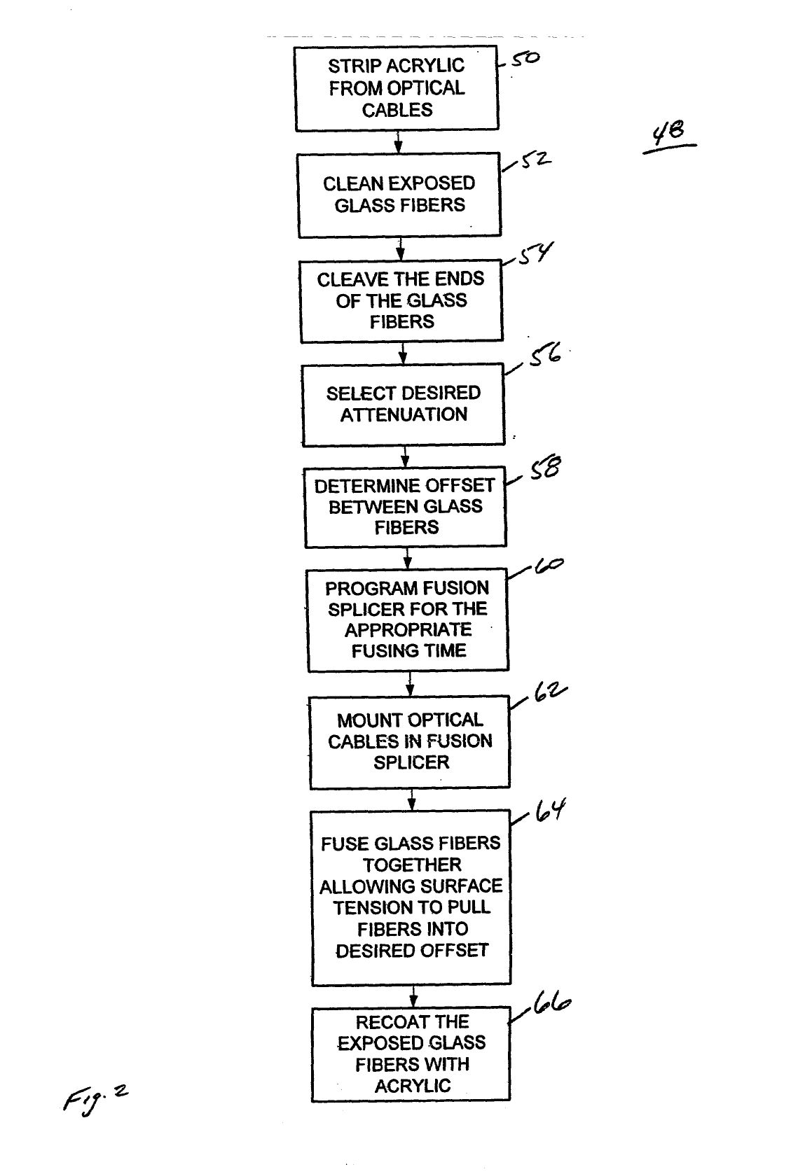

The following description, in conjunction with FIG. 2, illustrates one manner in which optical fibers may be spliced to achieve significant attenuation while maintaining tensile strength. FIGS. 3-6 and 8-10 are exemplary illustrations of what two optical cables might look like as they are processed according to the technique described in connection with FIG. 2.

Turning now to FIG. 2, a process 48 for splicing optical fibers at a junction that provides attenuation is shown in flow diagram form as including numerous segments 50-66, which are described in detail hereinafter. As will be readily appreciated by those having ordinary skill in the relevant art, the order of the segments of FIG. 2 is merely illustrative and many permutations regarding the ordering of such segments may be made.

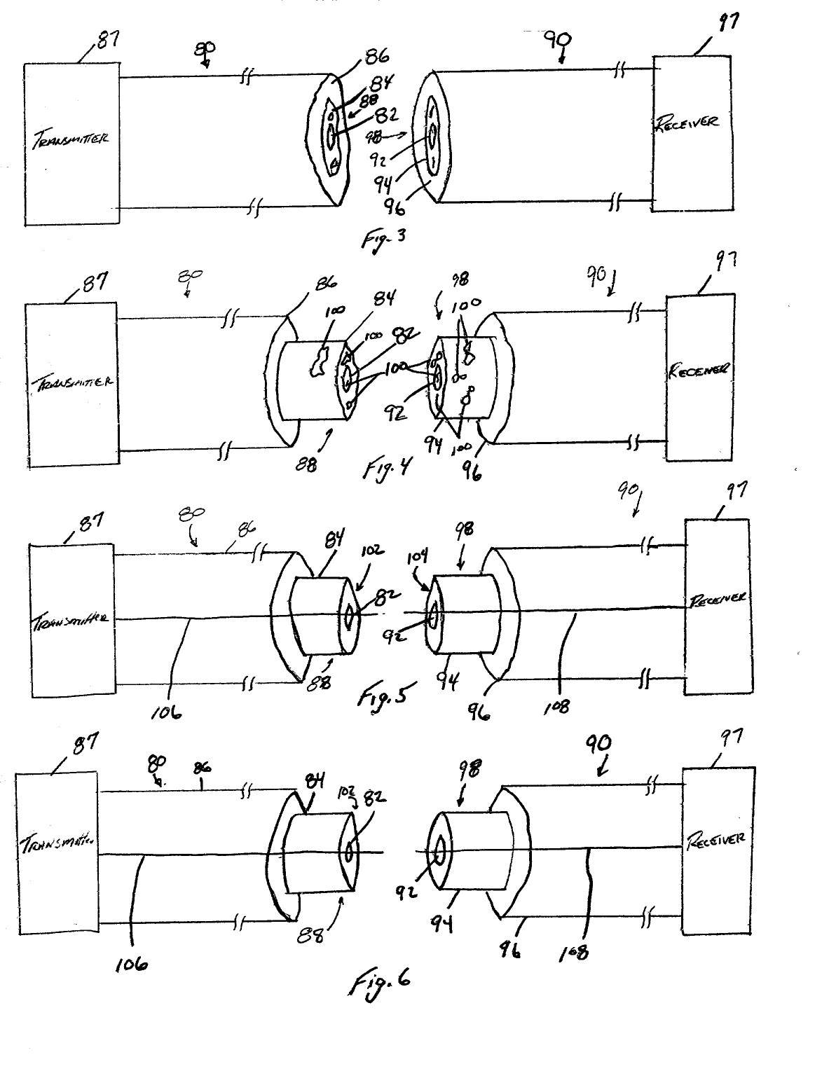

As shown in FIGS. 3 and 4, a first optical cable 80 including a core 82, cladding 84 and an acrylic layer 86 is coupled to an optical transmitter 87. Additionally, a second optical cable 90 also including a core 92, cladding 94 and an acrylic layer 96 is coupled to an optical receiver 97. The core 82 and cladding 84 may be referred to as an optical fiber 88 and the core 92 and the cladding 94 may be referred to as an optical fiber 98. Collectively, the optical transmitter 87 along with the optical cables 80, 90 may be referred to as an optical transmission system.

The optical cables 80, 90 may be any suitable single-mode optical cable. For example, the optical cables 80, 90 may be an optical cable that is commercially available from Corning® under the model number SMF-28™. The SMF-28™ cable may used for communications at 1310 nm or 1550 nm and may be constructed with an 8.2 μm diameter core, a 125 μm diameter cladding and a 245 μm overall diameter. The optical transmitter 87 may be any suitable optical transmitter that may be manufactured by or used in an optical assembly produced by, for example, Corning®, Agere®, SDL®, Alcatel®, Gtran®, NetworkElements® or JDS Uniphase®.

The acrylic layers 86, 96 are stripped from the optical cables 80, 90 at segment 50. Stripping acrylic layers 86, 96 from optical fibers 88, 98 is a well known procedure that may be carried out using a device named the Miller Hot Stripper. Alternatively, there are a number of commercially available acrylic strippers, any one of which may be used to strip the acrylic layers 86, 96 from the optical cable 80, 90 in FIG. 3 to achieve the result shown in FIG. 4. The acrylic layers 86, 96 may be stripped back any suitable distance such as, for example, 10 millimeters (mm).

After the acrylic layers 86, 96 have been appropriately stripped from the optical cable 80, 90 to reveal lengths of cladding 84, 94 and cores 82, 92 protruding from the acrylic layers 86, 96, the exposed optical fibers 88, 98 are cleaned at segment 52. As shown in FIG. 4, the cladding 84, 94 and the cores 82, 92 may include some contamination, which is generally referred to by reference numeral 100. Cleaning the optical fibers 88, 98, which is a process known to those having ordinary skill in the relevant art, may be accomplished using isopropanol alcohol (IPA) or any other suitable chemical solution. As shown in FIG. 5, the contamination 100 is removed during the cleaning segment 52. As shown in FIG. 5, after the cleaning segment 52, the optical fibers 88, 98 include clean lengths of cladding 84, 94 and core 82, 92 protruding from the acrylic layers 86, 96. However, the ends or faces 102, 104 of the cores 82, 92 and cladding 84, 94 may not be square, meaning that the faces 102, 104 may not be perpendicular to longitudinal axes 106, 108 of the optical fibers 88, 98.

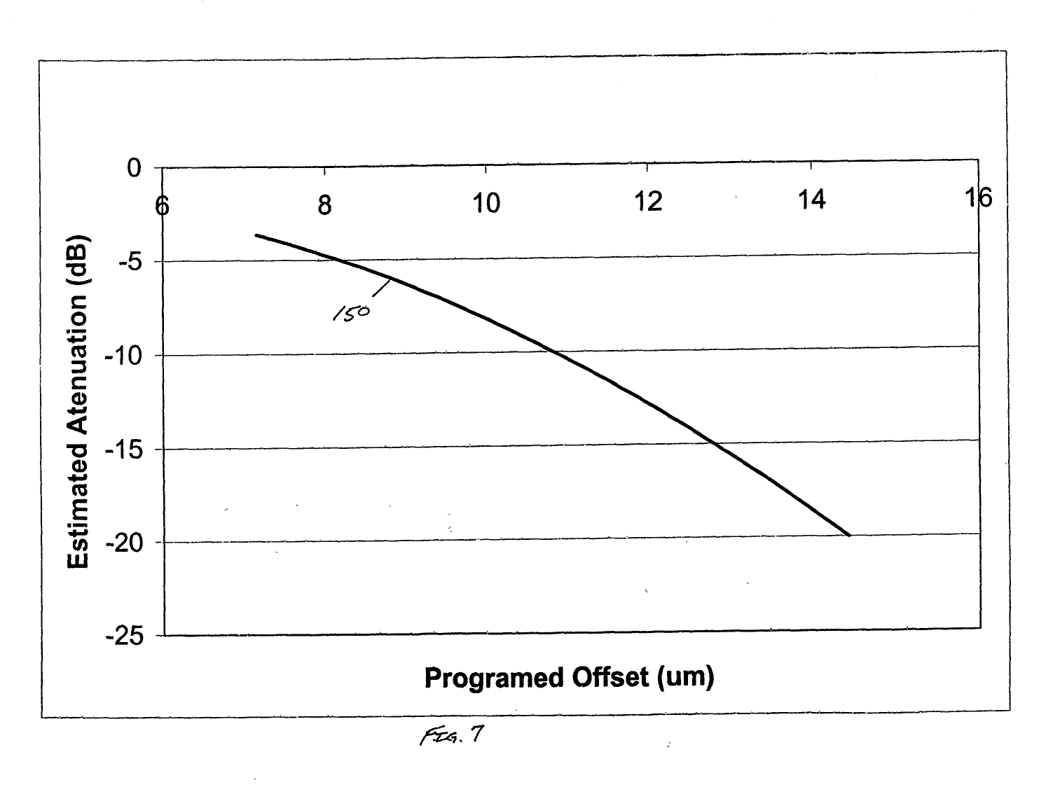

Accordingly, after the segment 52 is completed, a segment 54 is performed for the purpose of making the faces 102, 104 of the optical fibers 88, 98 perpendicular to the longitudinal axes 106, 108 of the optical fibers 88, 98, which define the radial centers of the optical fibers 88, 98. At the segment 54, the faces 102, 104 are cleaved using, for example, an Oxford Cleaver, or any other suitable cleaver that is known to those having ordinary skill in the relevant art. The result of the segment 54 may be seen in FIG. 6, which illustrates that the faces 102, 104 of the optical fibers 88, 98 are perpendicular, or at least substantially perpendicular, to the axes 106, 108.

After the segments 50-54 have been performed, the optical fibers 88, 98 are in condition to be fused together. The segments 56-64 of the process 48, as described below, pertain to fusing the optical fibers 88, 98 together in a manner in which a desired attenuation is achieved and tensile strength of the splice or junction between the optical fibers 88, 98 is maintained.

Returning now to the description of the process 48, at segment 56 a desired attenuation for the splice is selected. The magnitude of the desired attenuation may depend, among other things, on the optical output power of a particular optical transmitter and the optical power desired by a customer who will purchase the optical transmitter. For example, if a particular transmitter has a 13 dBm output power and a customer desires to purchase optical transmitters having only 3 dBm of output power, an attenuation of 10 dB (or, put another way, a gain of −10 dB) is needed. Accordingly, an attenuation of 10 dB will be selected at segment 56. The following description will carry forward the example of 10 dB as the desired attenuation.

At this point, after the desired attenuation has been selected, it should be noted that, as described in detail below in conjunction with segments 58 and 60, the desired attenuation may be achieved by offsetting the radial centers of the optical fibers 88, 98 by different distances, while keeping the heating, or fusing, time constant. For example, an offset of 11 μm may create an attenuation of 13 dB with a 17 second(s) heating or fusing time, while an offset of 6 μm may create an attenuation of 5 dB with that same heating time. A desired attenuation between the two optical fibers 88, 98 is created by offsetting the optical fibers 88, 98 by a first distance and moving, or allowing the optical fibers 88, 98 to move to an offset of a second and smaller distance while the optical fibers 88, 98 are heated. Using this technique gives rise to desired attenuation that is in better condition to pass compliance tensile strength tests such as, for example, the afore-mentioned Telcordia specification.

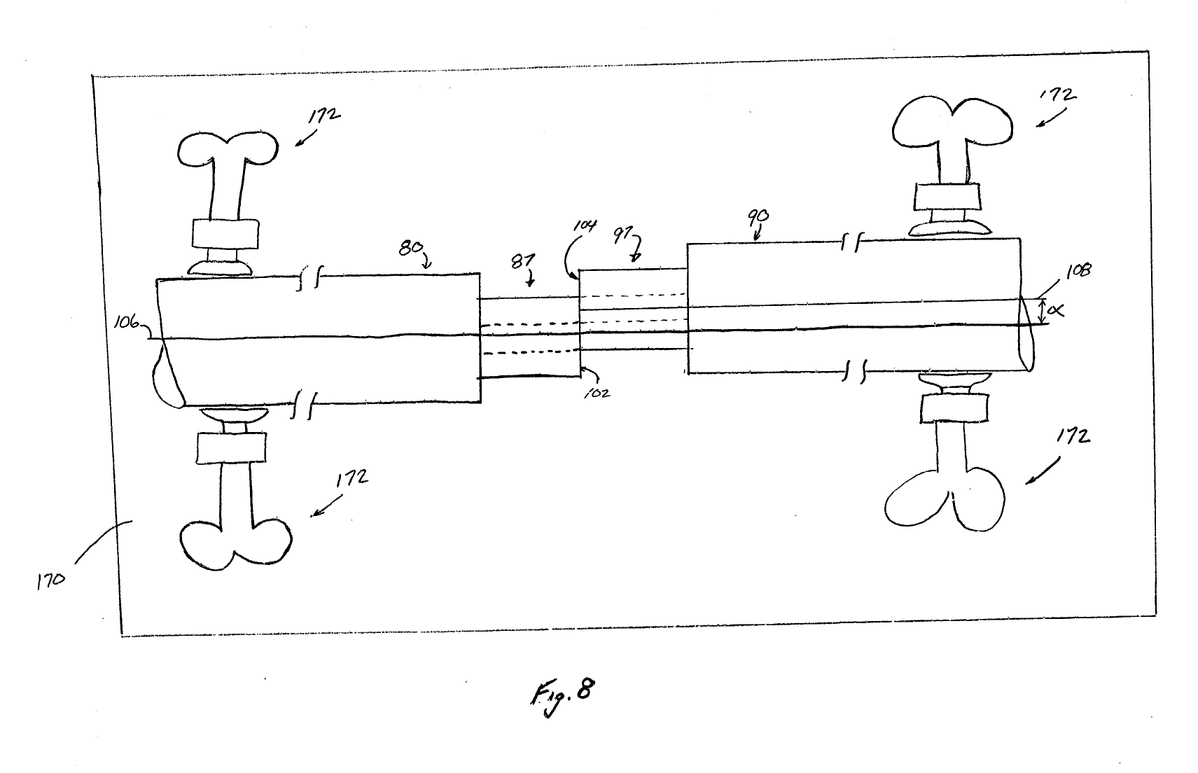

Returning to the description of the process 48, after the desired attenuation is selected at segment 56, an offset between the longitudinal axes 106, 108 (or the radial centers) of the optical fibers 88, 98 is determined at segment 58. If the heating time is constant across all desired attenuations, an offset curve, such as the empirically derived curve 150 shown in FIG. 7 may be used to determine the offset needed between the longitudinal axes 106, 108 of the optical fibers 88, 98 to create the desired attenuation after the optical fibers 88, 98 are heated. The offset changes with desired attenuation because as the optical fibers 88, 98 are heated for the fixed time, the longitudinal axes 106, 108 of the optical fibers 88, 98 drift, due to surface tension between the optical fibers 88, 98, from the initial position selected in conjunction with the curve 150 of FIG. 7, to a position having a smaller offset between the longitudinal axes 106, 108. For example, the fixed heating time associated with the curve 150 of FIG. 7 is 17 s. For that fixed heating time, an attenuation of 10 dB requires an initial offset of approximately 10.7 μm. Accordingly, the result of the segment 58 is the selection of the offset of 10.7 μm.

It should be noted that, while the foregoing description pertains to determining the offset between the longitudinal axes 106, 108 of the optical fibers 88, 98 by looking at the curve 150, it is possible to calculate an offset using an equation such as Equation 1 provided below.

y=−0.143x²+0.8355x−2.2829 Equation 1

In Equation 1, the dependent variable y represents the desired attenuation and the independent variable x represents the offset between the longitudinal centers 106, 108 of the optical fibers 88, 98. While Equation 1 represents one empirically derived relationship between offset and attenuation, it will be readily appreciated by those having ordinary skill in the art that more or different equations modeling the relationship between offset and attenuation may be derived and used in conjunction with the disclosure contained herein.

After the offset has been selected at segment 58, a fusion splicer will be programmed for the appropriate fusing or heating time. The fusion splicer may be, for example, a product that is commercially available from Ericsson Cables AB of Stockholm, Sweden under the model number of FSU 975, which is a fusion splicer for splicing single fibers. As noted previously, the time for which the fusion splicer is programmed may be fixed no matter the magnitude of the desired attenuation. For example, if the offset between the optical fibers 88, 98 is varied, as shown in FIG. 7, to create various attenuations, the heating time may be fixed.

After the segments 58 and 60 of the process 48 have been completed and the offset and heating time have been selected, the optical cables 80, 90 are mounted in the fusion splicer. As shown in FIG. 8, the fusion splicer may include a plate 170 including a plurality of clamps 172 between which each of the optical cables 80, 90 may be mounted. As shown in FIG. 8, the optical fibers 88, 98 have longitudinal axes 106, 108 (or radial centers) that are offset from one another by a distance (denoted as α) that is either selected according to the curve 150 of FIG. 7 or according to Equation 1. Additionally, the faces 102, 104 of the optical fibers 88, 98 are brought into proximity with one another. In keeping with the running example, the distance a is 8.2 μm so that the splice will create 10 dB of attenuation. The actual clamps used by the fusion splicer may, in reality, differ from the style those shown in FIG. 8 because those shown in FIG. 8 are merely representational and are not intended to replicate the actual clamp configuration of the fusion splicer.

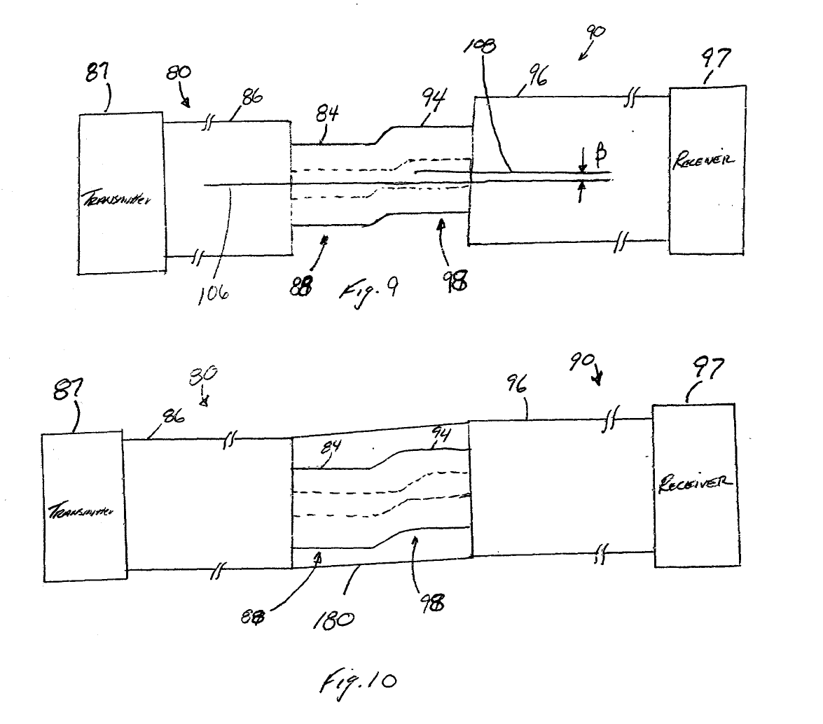

After the optical cables 80, 90 have been mounted in the fusion splicer in segment 62, the optical fibers 88, 98 are fused together with a splice having the desired attenuation in segment 64. During the segment 64, the optical fibers 88, 98 are heated by the fusion splicer and the surface tension from the melting of the faces 102, 104 of the optical fibers 88, 98 pulls the longitudinal axes 106, 108 of the optical fibers 88, 98 more closely into alignment. The result of performing the segment 64 is shown in FIG. 9. Whereas the distance between the longitudinal centers 106, 108 of the optical fibers was denoted as α in FIG. 8, the distance between the longitudinal centers 106, 108 is shown as β in FIG. 9, wherein the distance α is greater than the distance β. For an offset of 10.7 μm and a heating time of 17 seconds a back reflection free attenuation of 10 dB is created.

After the optical fibers 88, 98 have been fused at segment 64, the exposed cladding 84, 94 is recoated with acrylic at segment 66. The recoating of segment 64 may be carried out using a recoater that is commercially available from, for example, Vytan and has model number PRT-200. The recoating process deposits a portion of acrylic 180 over the exposed cladding 84, 94 to form a virtually seamless junction between the coating 86 and the coating 96.

After the acrylic 180 is applied, the entire unitary fiber optic cable including the portions formerly individually referred to with reference numerals 80 and 90, may be upcoated to another diameter such as, for example, 900 μm. Upcoating may be carried out using a tube or cylinder of Hytrel® or any other polyvinyl chloride (PVC)-based product that may be slipped over the 245 μm optical cable and glued, or otherwise fastened, in place.

Although certain techniques and apparatus have been described herein, the scope of coverage of this patent is not limited thereto. On the contrary, this patent covers all embodiments of the teachings of the invention fairly falling within the scope of the appended claims either literally or under the doctrine of equivalents.

What is claimed is:

1. A method of making an attenuator between a first optical fiber of a first optical cable having a first end and a first radial center and a second optical fiber of a second optical cable having a second end and a second radial center, the method comprising:
selecting a desired attenuation for the attenuator;
determining a first offset between the radial centers of the first and second optical fibers;
bringing the first and second ends of the first and second optical fibers into proximity with one another, while the radial centers of the first and second optical fibers are held at the first offset;
starting to heat the first and second ends of the first and second optical fibers;
allowing the radial centers of the first and second optical fibers to move toward one another until there is a second offset between the radial centers of the first and second optical fibers; and
ceasing to heat the first and second ends of the first and second optical fibers.

2. The method of claim 1, wherein the first optical fiber comprises a first longitudinal axis and the second optical fiber comprises a second longitudinal axis, the method further comprising cleaving the first and second ends of the first and second optical fibers so that the first and second ends of the first and second fibers are substantially perpendicular to the first and second longitudinal axes.

3. The method of claim 1, wherein a time period between starting to heat the first and second ends of the first and second optical fibers and ceasing to heat the first and second ends of the first and second optical fibers is inversely proportional to the desired attenuation.

4. The method of claim 1, wherein the second offset is proportional to the desired attenuation.

5. The method of claim 1, wherein the first and second optical cables each comprise an acrylic coating over the first and second optical fibers, and wherein the acrylic coating is removed from the first and second optical fibers before bringing the first and second ends of the first and second optical fibers into proximity with one another.

6. The method of claim 1, further comprising coating the first and second ends of the first and second optical fibers with an acrylic coating after ceasing to heat the first and second ends of the first and second optical fibers.

7. The method of claim 1, wherein surface tension pulls the radial centers of the first and second optical fibers to the second offset.

8. A method of splicing a first end of a first optical cable comprising a first core, first cladding, a first coating and a first radial center to a second end of a second optical cable comprising a second core, second cladding, a second coating and a second radial center in a manner that creates attenuation, the method comprising:
removing a length of each of the first and second coatings from the first and second optical cables;
selecting a desired attenuation for the splice between the first end of the first optical cable and the second end of the second optical cable;
determining a first offset between the radial centers of the first and second optical cables;
bringing the first and second ends of the first and second optical cables into proximity with one another, while the radial centers of the first and second optical cables are held at the first offset;
heating the first and second ends of the first and second optical cables for a predetermined time period; and
allowing the radial centers of the first and second optical cables to move toward one another to create a second offset between the radial centers of the first and second optical cables.

9. The method of claim 8, wherein the first optical cable comprises a first longitudinal axis and the second optical cable comprises a second longitudinal axis, the method further comprising cleaving the first and second ends of the first and second optical cables so that the first and second ends of the first and second cables are substantially perpendicular to the first and second longitudinal axes.

10. The method of claim 8, further comprising coating the first and second ends of the first and second optical cables with an acrylic coating after heating the first and second ends of the first and second optical cables for a predetermined time period.

11. The method of claim 8, wherein the first offset is proportional to the desired attenuation.

12. The method of claim 8, wherein surface tension pulls the radial centers of the first and second optical cables to the second offset.

13. The method of claim 8, wherein the predetermined time period comprises approximately 17 seconds.

14. An optical transmission system having an attenuated output, the system comprising:
an optical transmitter;
a first optical cable coupled to the optical transmitter, the first optical cable comprising a first end, a first core, first cladding, a first coating and a first longitudinal axis;
a second optical cable spliced to the first optical cable, the second optical cable comprising a second end, a second core, second cladding, a second coating and a second longitudinal axis;
wherein the first and second optical cables are spliced together by:
removing a length of each of the first and second coatings from the first and second optical cables to expose the claddings of the first and second optical cables;
cleaving the first and second ends of the first and second optical cables so that they are substantially perpendicular to the first and second longitudinal axes;
selecting a desired attenuation for the splice between the first end of the first optical cable and the second end of the second optical cable;
determining a first offset based on the desired attenuation;
bringing the first and second ends of the first and second optical cables into proximity with one another, while the longitudinal axes of the first and second optical cables are held at the first offset;
heating the first and second ends of the first and second optical cables for a predetermined time period; and
allowing surface tension to pull the longitudinal axes of the first and second optical fibers toward one another to a second offset while the first and second ends of the first and second optical cables are heated.

15. The system of claim 14, wherein splicing the first and second optical cables further comprises coating the first and second ends of the first and second optical cables with an acrylic coating after heating the first and second ends of the first and second optical cables for a predetermined time period.

16. The system of claim 14, wherein the first offset between the longitudinal axes of the first and second optical cables is proportional to the desired attenuation.

17. The system of claim 14, further including the cleaning the exposed claddings of the first and second optical cables.

18. The system of claim 14, wherein the predetermined heating line comprises approximately 17 seconds.

19. An optical transmission system having an attenuated output, the system comprising:
an optical transmitter;
a first optical cable coupled to the optical transmitter, the first optical cable comprising a first end, a first core, first cladding, a first coating and a first longitudinal axis;
a second optical cable spliced to the first optical cable, the second optical cable comprising a second end, a second core, second cladding, a second coating and a second longitudinal axis;
wherein the first and second optical cables are spliced together by:
removing a length of each of the first and second coatings from the first and second optical cables;
selecting a desired attenuation for the splice between the first end of the first optical cable and the second end of the second optical cable;
determining a first offset between the radial centers of the first and second optical cables;
bringing the first and second ends of the first and second optical cables into proximity with one another, while the radial centers of the first and second optical cables are held at the first offset;
heating the first and second ends of the first and second optical cables for a predetermined time period; and
allowing the radial centers of the first and second optical cables to move toward one another to create a second offset between the radial centers of the first and second optical cables.

20. The system of claim 19, wherein splicing the first and second optical cables further comprises coating the first and second ends of the first and second optical cables with an acrylic coating after heating the first and second ends of the first and second optical cables for a predetermined time period.

21. The system of claim 19, wherein the first offset between the longitudinal axes of the first and second optical cables is proportional to the desired attenuation.

22. The system of claim 19, further including the cleaning the exposed claddings of the first and second optical cables.

23. An attenuator comprising:
a first optical cable;
a second optical cable;
a junction joining the first and second optical cables such that the second optical cable is offset from the first optical cable to create at least three decibels of attenuation for a signal passing between the first and second optical cables and such that the first and second optical cables and the junction have at least one kilogram of tensile strength.

24. The attenuator of claim 23, wherein the magnitude of the offset between of the first and second optical cables is proportional to the attenuation provided by the junction.
